(19) United States
(12) Patent Application Publication
(10) Pub. No.: US 2003/0087628 A1
(43) Pub. Date: May 8, 2003

(54) Cellular phone equipped with crime or disaster precention means

(75) Inventor: Yasuyo Michibata, Fukui (JP)

Correspondence Address: RADER, FISHMAN & GRAUER, PLLC, Suite 501, 1233 20th Street, N.W., Washington, DC, 20036, US

(73) Assignee: Eiichi HIRAUCHI

(21) Appl. No.: 09/985,832

(22) Filed: Nov. 6, 2001

(51) Int. Cl. H04M 11/00

(52) U.S. Cl. 455/404; 455/550

(57) ABSTRACT

Disclosed is a cellular phone equipped with crime or disaster prevention means. It has an extra push button at a predetermined position on its body. The extra push button has a safety lock such as a cover for preventing inadvertent depression for telephoning police or fire stations or security companies. The cellular phone has a GPS function installed therein for informing them of the instantaneous location of the telephoner.

### BACKGROUND OF THE INVENTION

1. Field of the Invention

The present invention relates to a cellular phone and more particularly to a cellular phone having help-calling means installed therein.

2. Related Arts

Recently almost all people carry cellular phones, and it is said that in near future the number of people carrying cellular phones is one billion or more. People can use their cellular phones everywhere for telephoning. Accordingly their communication areas have been expanded to meet the needs of expanding world of business or urgent information, and from this point of view cellular phones are one of the tools indispensable to today's community.

Japan is supposed to be one of the safest countries in the world. As a matter of fact, however, a terrible slaughter was committed by the religious group called OHM in 1995, and as a recent tendency burglaries have been taken places in districts. Also, organized criminals by foreigners have been increasing in number. For instance, a gang of burglars broke into convenience stores midnight. In United States of America a certain tall building was crushed by some terrorists. Nobody can tell when and where you meet a serious accident.

Serious criminals have been increasing beyond the official capability of protecting people and property. In spite of such circumstances, citizens have no means for protecting themselves from such criminals. In a case where they are attacked by gangsters all of sudden, they cannot use their cellular phones to inform the police station of their sufferings by dialing the help-calling number 911. The cellular phone, therefore, can be no anti-criminal tool for calling for help.

Some people carry crime prevention buzzers or alarm buzzers with them, which are responsive to pulling their strings or pushing their buttons for alarming. Such tools, however, are large in size, and are liable to be left behind because their use is rare. It may be most probable that they carry no crime prevention buzzers with them when in need.

As a matter of fact, the sound produced by such an crime prevention buzzer is hardly distinguishable from those produced by the cellular phone, the bicycle bell, the fire alarm or gas-leak alarm, and therefore, nobody is aware of calling for help. Usually any person who is attacked by gangsters cannot afford to produce and pull the string of the crime prevention buzzer.

The inventor filed a patent application on Jun. 20, 1997, claiming an “crime prevention system” for patent (Japanese Patent H11-16056). The “crime prevention system” can be reduced to practice in the form of wristwatch or band buckle, and it has clock function, name-and-address presenting function or signal-transmitting function. This tool can be worn all the time, causing no feeling of obstacle, and it is responsive to depression of its button for transmitting signals representing his or her location. It is small in size, but still larger compared with the wristwatch size.

### SUMMARY OF THE INVENTION

In view of the above one object of the present invention is to provide a cellular phone equipped with crime or disaster prevention means, which is capable of calling for help while informing the police station or other security services of the instantaneous location of the telphoner.

To attain this object a cellular phone equipped with crime or disaster prevention means has the following functions:

(1) the function of dialing the emergency telephone number, 911:

the cellular phone has an extra push button (number 911 dialing button) at a predetermined position on its body. The extra push button has a safety lock such as an acrylic glazing cover for preventing inadvertent depression for telephoning police or fire stations or security companies. A required telephoning, therefore, is permitted when breaking the acrylic glazing cover. Depression of the extra push button permits automatic transmission and information of his or her name, address, sex, blood type, telephone numbers to make telephone calls in emergency and other particulars. Even if the cellular phone turns off, depression of the extra push button makes the cellular phone turn on. Even if the battery has been exhausted, depression of the extra push button permits the cellular phone to be put in circuit with an auxiliary battery, which is installed in the cellular phone.

(2) the telephoner-locating function or the GPS function:

depression of the extra push button makes the cellular phone perform the GPS function. Some types of cellular phones have a GPS function installed therein. Such cellular phones can be modified by providing an extra push button on their bodies and by making the GPS function start in response to depression of the extra push button, thereby informing the police or fire station or other security services of the instantaneous location of the telephoner.

(3) the function of recording and transmitting the state of being suffered:

depression of the extra push button permits not only information of the instantaneous location of the telephoner but also the recording and transmitting of the on-the-spot suffering situation in the form of sound. The cellular phone is equipped with a microphone of high-sensitivity. The recording is effective for policemen to realize the situation and think of the manner of saving the victim, and is useful in chasing and arresting criminals.

(4) remote controlling function:

in a case where a person having no cellular phone with him or her happens to encounter a serious accident, the person can use a small-sized transmitter to actuate the extra push button of the cellular phone in distance. Assuming that a woman is deprived of her handbag, and that her cellular phone is put in her handbag, she can make her cellular phone to perform the above-described functions by operating the small-sized transmitter, which is installed in an accessory worn by her.

(5) other functions:

depression of the extra push button (number 911) permits the cellular phone to automatically contact with the police or fire station, informing them of the instantaneous location of the telephoner. The red light may be flickering in darkness to indicate the spot. Depression of the extra push button produces the patrol or ambulance siren or the utterance calling for help. The cellular phone may have a dog-sensitive ultrasonic wave transmitter equipped therewith, thereby calling police dogs.

The cellular phone may be equipped with a means responsive to depression of the extra push button for vibrating the cellular phone body, thereby permitting him or her to confirm that the cellular phone is working in emergency mode.

Other objects and advantages of the present invention will be understood from the following description of cellular phones equipped with crime or disaster prevention means according to the present invention, which are shown in accompanying drawings.

### BRIEF DESCRIPTION OF THE DRAWING

FIG. 1 is a front view of a cellular phone according to one embodiment of the present invention;

FIG. 2 is a longitudinal section of the extra push button; and

FIG. 3 illustrates how the remote control can be effected on the cellular phone.

### DETAILED DESCRIPTION OF PREFERRED EMBODIMENT

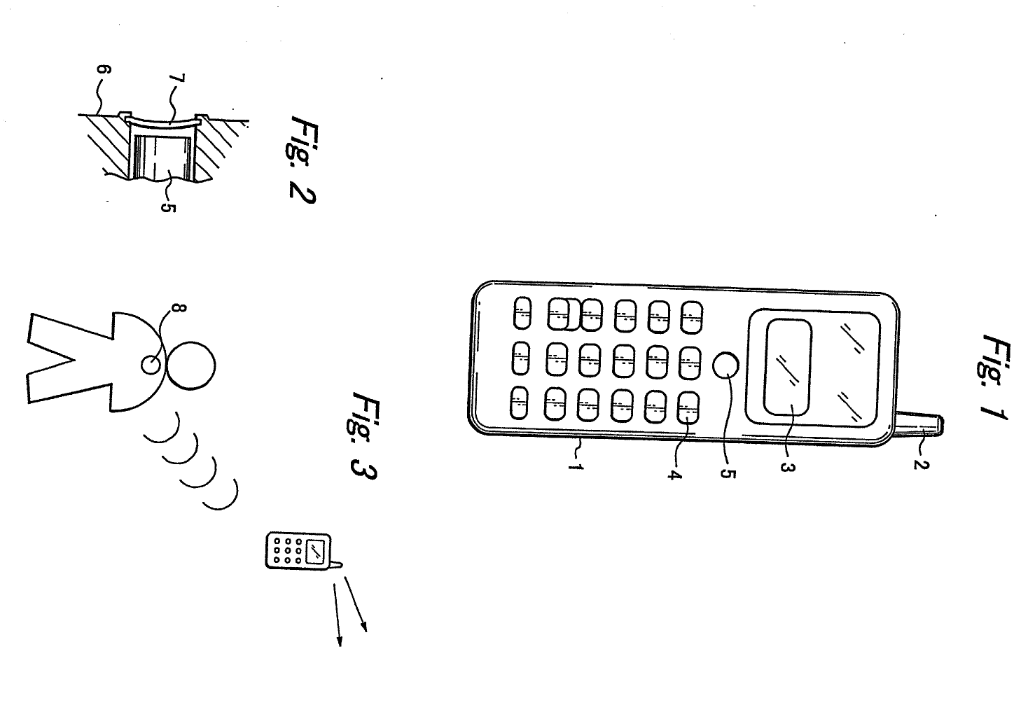

Referring to FIG. 1, a cellular phone according to one embodiment of the present invention looks like a conventional cellular phone in appearance. Its body 1 is small enough to be held in hand. The body 1 has an antenna 2 provided on its top, and a display 3 and digit buttons 4, 4 . . . arranged at regular intervals on its front.

The cellular phone has an extra push button 5 just below the display 3. Of course, selected digit buttons 4, 4 . . . are depressed to connect the cellular phone to the police or fire station. Depression of the extra push button (telephone number 911 dialing button) 5 in the cellular phone permits connection to the police or fire station.

It is difficult or next to impossible to telephone the police or fire station by depressing selected digit buttons 4, 4 . . . in emergency. To be sure of telephoning the police or fire station in emergency, the cellular phone has the extra push button 5 for exclusive use in connecting to the police or fire station in emergency. The extra push button 5 is colored in red or yellow to be distinguished from the other push buttons, and is not exposed on the front of the cellular phone, different from the other push buttons 4, 4 . . . , thus preventing the extra push button 5 from being depressed inadvertently.

Referring to FIG. 2, the extra push button 5 is put in the recess made on the front of the cellular phone, so that the top of the extra push button may be a short distance deep from the front surface of the cellular phone, and a safety glass 7 closes the recess. Thus, inadvertent depression of the extra push button 5 can be completely prevented, and it cannot be depressed without breaking the safety glass 7, which may be an acrylic glazing. When the safety glass 7 is broken to depress the extra push button 5, the cellular phone is connected to the police or fire station automatically at once. When occasions demand, the cellular phone can be connected to a selected security company, who contacts the police station by telephone. Another depression of the extra push button permits it to return to its original position.

Simultaneously with depression of the extra push button 5 signals representing the name, address, birthday, sex, telephone number to be dialed in emergency, location of emergency and other useful pieces of information are sent automatically. It is possible that these pieces of information are stored in the storage library at the police station or the security company, and that they are retrieved from the storage library in terms of the telephone number of the cellular phone, which is just connected to the police station or the security company to call for help. The location of emergency can be determined with the aid of GPS function, as for instance follows: the spot is indicated in the map appearing on the display of a personal computer or a map having the spot marked therein is sent by facsimile.

The instantaneous location of emergency may be transmitted to a particular emergency service center, where the name, address and other particulars of the victim or sufferer can be determined in terms of the telephone number of the cellular phone, and then, the emergency service center cooperates with the police or fire station to save the victim or sufferer.

The cellular phone may be equipped with sounding means, which is responsive to depression of the extra push button for producing the siren of the patrol car or ambulance or for producing the human voice calling for help. Ultrasonic wave sensitive to dogs may be radiated, and red light may flicker to indicate the spot in darkness.

In order to let the police or fire station know what is happening at the spot thus located, the on-the-spot suffering situation is transmitted to the police or fire station in the form of sound and voice by wire. The microphone and recorder installed in the cellular phone can record the on-the-spot sufferings.

Referring to FIG. 3, the manner in which the cellular phone can be remote-controlled is described. A cellular phone has a separate small-sized transmitter 8 as attachment, and it can send a signal to the cellular phone for putting the extra push button in operation. Such a small-sized transmitter can be installed in a pendant or ring or a belt buckle, which are worn by her or him all the time.

Assuming that a woman puts a cellular phone in her handbag, wearing an accessory having an auxiliary transmitter installed therein, and that she is deprived of her handbag, she operates the auxiliary transmitter to allow the cellular phone to make contact with the police station or the security company, calling for help.

As may be understood from the above, the cellular phone equipped with crime or disaster prevention means according to the present invention provides the following advantages:

1) depression of the extra push button causes communication with the police or fire station for informing the location of emergency, and produces the siren for calling for help. This prevents a person involved in trouble from dialing wrong numbers or failing correct transmission owing to the upsetting in emergency;

2) depression of the extra push button causes the flickering of the red light for indicating the spot of emergency in darkness, and the recording of the on-the-spot sufferings. The recording can be transmitted to the police station, thereby permitting policemen to make plans for saving the victim and arresting the criminal; and

3) the extra push button can be remote-controlled by an associated small-sized transmitter, which may be installed in a small article worn all the time. Thus, a person involved in trouble can contact the police or fire station over the cellular phone simply by using the auxiliary transmitter even though the cellular phone is remote from the person.

What is claimed is:

1. A cellular phone equipped with crime or disaster prevention means, comprising an extra push button for telephoning police, fire stations or security companies at a predetermined position on its body, the extra push button having a safety lock such as a cover for preventing inadvertent depression; and a GPS function installed therein for informing the police, fire stations or security companies of instantaneous location of telephoner.

2. A cellular phone according to claim 1, wherein it further comprises a sounding function responsive to depression of the extra push button for producing a patrol, an ambulance siren or an utterance calling for help.

3. A cellular phone according to claim 1, wherein it further comprises a dog-sensitive ultrasonic wave transmitter equipped therewith.

4. A cellular phone according to claim 1, wherein it further comprises a red light flickering means equipped therewith.

5. A cellular phone according to claim 1, wherein it further comprises an automatic recording function for recording on-the-spot suffering situation or sufferings in the form of sound.

6. A cellular phone according to claim 1, wherein it further comprises a transmitter section for automatically informing police or fire stations of the on-the-spot suffering situation or sufferings.

7. A cellular phone according to any of claims 1, wherein it further comprises a separate transmitter as attachment, the separate transmitter being designed so as to facilitate carrying the same with his or her body all the time, and so as to send signals to the cellular phone to make the extra push button work.

8. A cellular phone according to claim 1, wherein it further comprises a means for telephoning selected rescue centers in addition to the police, fire stations or security companies by using the GPS function for informing them of the instantaneous location of the telephoner.

9. A cellular phone according to claim 7, wherein the separate transmitter is installed in a small-sized article which is worn by him or her all the time.
